(19) United States
(12) Patent Application Publication
(10) Pub. No.: US 2015/0149465 A1
(43) Pub. Date: May 28, 2015

(54) METHOD AND SYSTEM FOR INTEGRATING VEHICLE DATA WITH TRANSACTION DATA

(71) Applicant: MasterCard International Incorporated, Purchase, NY (US)

(72) Inventors: Kenny UNSER, Fairfield, CT (US); Serge BERNARD, Danbury, CT (US); Nikhil MALGATTI, Stamford, CT (US)

(73) Assignee: MasterCard International Incorporated, Purchase, NY (US)

(21) Appl. No.: 14/087,994

(22) Filed: Nov. 22, 2013

(51) Int. Cl. G06F 17/30

(52) U.S. Cl. CPC G06F 17/30598
USPC 707/738

(57) ABSTRACT

A method for linking vehicle data to transaction history includes: storing, in a database, a plurality of consumer profiles, wherein each consumer profile includes data related to a consumer including at least a plurality of consumer characteristics and a plurality of transaction data entries, each transaction data entry corresponding to a payment transaction involving the related consumer; receiving, by a receiving device, a vehicle profile, wherein the vehicle profile includes vehicle data associated with a specific consumer and a plurality of demographic characteristics associated with the specific consumer; identifying, by a processing device, at least one consumer profile of the plurality of consumer profiles where at least a predefined number of the included plurality of consumer characteristics correspond to the plurality of demographic characteristics; and associating, in the database, each of the identified at least one consumer profile with the vehicle data included in the received vehicle profile.

### FIELD

The present disclosure relates to the linking of vehicle data to transaction history, specifically the linking of consumer vehicle information with consumer transaction history based on a plurality of demographic characteristics.

### BACKGROUND

Transaction data, which may include any useful data captured from a payment transaction, may be useful in a variety of situations. Content providers, such as merchants, retailers, third party offer providers, or advertisers may utilize transaction data to identify targeted content, such as offers and advertisements, to distribute to potential consumers. Transaction data may provide valuable insights as to the potential for a specific consumer to redeem an offer or purchase an advertised product, based on their past transactions. However, in many instances, it may be difficult for an entity to identify the transaction data corresponding to a consumer until after a consumer presents their payment information, which may only occur once a consumer is already transacting. This may be less than ideal for content providers, as they may not be able to identify the consumer until the consumer is already transacting, and thus be unable to influence consumers that may otherwise not transact with them. Thus, there is a need for a technical solution to identify transaction data corresponding to consumers prior to the point of sale.

In addition, the identification of consumers prior to the point of sale may be beneficial for fraud prevention. Some methods of fraud prevention include authenticating a consumer as being an authorized consumer to use a particular payment account presented at the point of sale for the funding of a payment transaction. Traditional methods for authenticating a consumer include viewing a consumer's identification, such as a driver's license, or reviewing a consumer's signature (e.g., on the back of a payment card, on a driver's license, etc.) compared to a signature presented at the transaction (e.g., on the point of sale, on a receipt, etc.). However, such pieces of information may be readily compromised, such as by being stolen, fabricated, etc.

Many consumers that have payment accounts for which transaction data may be obtained, such as payment card (e.g., credit card) accounts, may also be associated with one or more vehicles (e.g., cars, trucks, motorcycles, bicycles, etc.). In many instances, these consumers may use an associated vehicle as transportation to or from a merchant with which the consumer is transacting. As a result, the vehicle's presence at or near a merchant may be a useful metric for identifying a consumer and their location at that particular merchant. However, current systems and methods for identifying a vehicle at a location do not combine the information with additional data that may be useful for content providers, payment processors, issuers, merchants, or acquirers.

Thus, there is a need for a technical solution to identify consumers, based on an associated vehicle, and to combine transaction data with additional useful data that may be beneficial, as well as use vehicle location data as a means for fraud prevention.

### SUMMARY

The present disclosure provides a description of systems and methods for linking vehicle data to transaction history, distributing consumer profiles, and processing payment transactions.

A method for linking vehicle data to transaction history includes: storing, in a database, a plurality of consumer profiles, wherein each consumer profile includes data related to a consumer including at least a plurality of consumer characteristics and a plurality of transaction data entries, each transaction data entry corresponding to a payment transaction involving the related consumer; receiving, by a receiving device, a vehicle profile, wherein the vehicle profile includes vehicle data associated with a specific consumer and a plurality of demographic characteristics associated with the specific consumer; identifying, by a processing device, at least one consumer profile of the plurality of consumer profiles where at least a predefined number of the included plurality of consumer characteristics correspond to the plurality of demographic characteristics; and associating, in the database, each of the identified at least one consumer profile with the vehicle data included in the received vehicle profile.

A method for distributing a linked consumer profile includes: storing, in a database, a plurality of consumer profiles, wherein each consumer profile includes data related to a consumer including at least a consumer identifier associated with the related consumer, a plurality of consumer characteristics, and a plurality of transaction data entries, each transaction data entry corresponding to a payment transaction involving the related consumer; receiving, by a receiving device, a consumer profile request, wherein the consumer profile request includes at least a specific consumer identifier; identifying, in the database, a specific consumer profile where the included consumer identifier corresponds to the specific consumer identifier; transmitting, by a transmitting device, a request for vehicle data, wherein the request for vehicle data includes at least the plurality of consumer characteristics included in the identified specific consumer profile; receiving, by the receiving device, vehicle data; including, in the database, the received vehicle data in the identified specific consumer profile; and transmitting, by the transmitting device, the specific consumer profile including the received vehicle data in response to the received consumer profile request.

A method for processing a payment transaction includes: storing, in a database, a plurality of consumer profiles, wherein each consumer profile includes data related to a consumer including at least a consumer identifier and vehicle data corresponding to a vehicle associated with the related consumer; receiving, by a receiving device, a vehicle notification, wherein the vehicle notification includes at least specific vehicle data associated with a specific vehicle, a geographic location where the specific vehicle was identified, and a vehicle date and/or time at which the specific vehicle was identified; receiving, by the receiving device, an authorization request for a payment transaction, wherein the authorization request includes at least transaction data, a merchant identifier, a specific consumer identifier, and a transaction date and/or time; identifying, in the database, a specific consumer profile where the included consumer identifier corresponds to the specific consumer identifier; generating, by a processing device, a score for the payment transaction based on at least the vehicle date and/or time, the transaction date and/or time, the geographic location, a location associated with a merchant corresponding to the merchant identifier, the specific vehicle data, and the vehicle data included in the specific consumer profile; and transmitting, by a transmitting device, at least the generated score.

A system for linking vehicle data to transaction history includes a database, a receiving device, and a processing device. The database is configured to store a plurality of consumer profiles, wherein each consumer profile includes data related to a consumer including at least a plurality of consumer characteristics and a plurality of transaction data entries, each transaction data entry corresponding to a payment transaction involving the related consumer. The receiving device is configured to receive a vehicle profile, wherein the vehicle profile includes vehicle data associated with a specific consumer and a plurality of demographic characteristics associated with the specific consumer. The processing device is configured to: identify at least one consumer profile of the plurality of consumer profiles where at least a predefined number of the included plurality of consumer characteristics correspond to the plurality of demographic characteristics; and associate, in the database, each of the identified at least one consumer profile with the vehicle data included in the received vehicle profile.

A system for distributing a linked consumer profile includes a database, a receiving device, a processing device, and a receiving device. The database is configured to store a plurality of consumer profiles, wherein each consumer profile includes data related to a consumer including at least a consumer identifier associated with the related consumer, a plurality of consumer characteristics, and a plurality of transaction data entries, each transaction data entry corresponding to a payment transaction involving the related consumer. The receiving device is configured to receive a consumer profile request, wherein the consumer profile request includes at least a specific consumer identifier. The processing device is configured to identify, in the database, a specific consumer profile where the included consumer identifier corresponds to the specific consumer identifier. The transmitting device is configured to transmit a request for vehicle data, wherein the request for vehicle data includes at least the plurality of consumer characteristics included in the identified specific consumer profile. The receiving device is further configured to receive vehicle data. The processing device is further configured to include, in the database, the received vehicle data in the identified specific consumer profile. The transmitting device is further configured to transmit the specific consumer profile including the received vehicle data in response to the received consumer profile request.

A system for processing a payment transaction includes a database, a receiving device, a processing device, and a transmitting device. The database is configured to store a plurality of consumer profiles, wherein each consumer profile includes data related to a consumer including at least a consumer identifier and vehicle data corresponding to a vehicle associated with the related consumer. The receiving device is configured to: receive a vehicle notification, wherein the vehicle notification includes at least specific vehicle data associated with a specific vehicle, a geographic location where the specific vehicle was identified, and a vehicle date and/or time at which the specific vehicle was identified; and receive an authorization request for a payment transaction, wherein the authorization request includes at least transaction data, a merchant identifier, a specific consumer identifier, and a transaction date and/or time. The processing device is configured to: identify, in the database, a specific consumer profile where the included consumer identifier corresponds to the specific consumer identifier; and generate a score for the payment transaction based on at least the vehicle date and/or time, the transaction date and/or time, the geographic location, a location associated with a merchant corresponding to the merchant identifier, the specific vehicle data, and the vehicle data included in the specific consumer profile. The transmitting device is configured to transmit at least the generated score.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for linking consumer vehicle data and transaction history in accordance with exemplary embodiments.

FIG. 2 is a high level architecture illustrating a system for using linked consumer vehicle data to identify a fraud score for a payment transaction in accordance with exemplary embodiments.

FIG. 3 is a block diagram illustrating the processing server of FIGS. 1 and 2 for the linking of consumer vehicle data and transaction history in accordance with exemplary embodiments.

FIG. 4 is a flow diagram illustrating a method for linking vehicle data with transaction history in a consumer profile in accordance with exemplary embodiments.

FIG. 5 is a flow chart illustrating a method for populating and distributing a consumer profile including vehicle data and transaction history in accordance with exemplary embodiments.

FIG. 6 is a diagram illustrating the linking of consumer vehicle data to transaction history in accordance with exemplary embodiments.

FIG. 7 is a flow chart illustrating a process for generating a transaction score for a payment transaction based on location data of a vehicle associated with a consumer involved in the payment transaction in accordance with exemplary embodiments.

FIG. 8 is a flow chart illustrating an exemplary method for linking vehicle data to transaction history in accordance with exemplary embodiments.

FIG. 9 is a flow chart illustrating an exemplary method for distributing a linked consumer profile in accordance with exemplary embodiments.

FIG. 10 is a flow chart illustrating an exemplary method for processing a payment transaction in accordance with exemplary embodiments.

FIG. 11 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Personally identifiable information (PII)—PII may include information that may be used, alone or in conjunction with other sources, to uniquely identify a single individual. Information that may be considered personally identifiable may be defined by a third party, such as a governmental agency (e.g., the U.S. Federal Trade Commission, the European Commission, etc.), a non-governmental organization (e.g., the Electronic Frontier Foundation), industry custom, consumers (e.g., through consumer surveys, contracts, etc.), codified laws, regulations, or statutes, etc. The present disclosure provides for methods and systems that do not possess any personally identifiable information. Systems and methods apparent to persons having skill in the art for rendering potentially personally identifiable information anonymous may be used, such as bucketing. Bucketing may include aggregating information that may otherwise be personally identifiable (e.g., age, income, etc.) into a bucket (e.g., grouping) in order to render the information not personally identifiable. For example, a consumer of age 26 with an income of $65,000, which may otherwise be unique in a particular circumstance to that consumer, may be represented by an age bucket for ages 21-30 and an income bucket for incomes $50,000 to $74,999, which may represent a large portion of additional consumers and thus no longer be personally identifiable to that consumer. In other embodiments, encryption may be used. For example, personally identifiable information (e.g., an account number) may be encrypted (e.g., using a one-way encryption) such that the systems and methods described herein may not possess the PII or be able to decrypt the encrypted PII.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Linking Vehicle Data to Transaction History

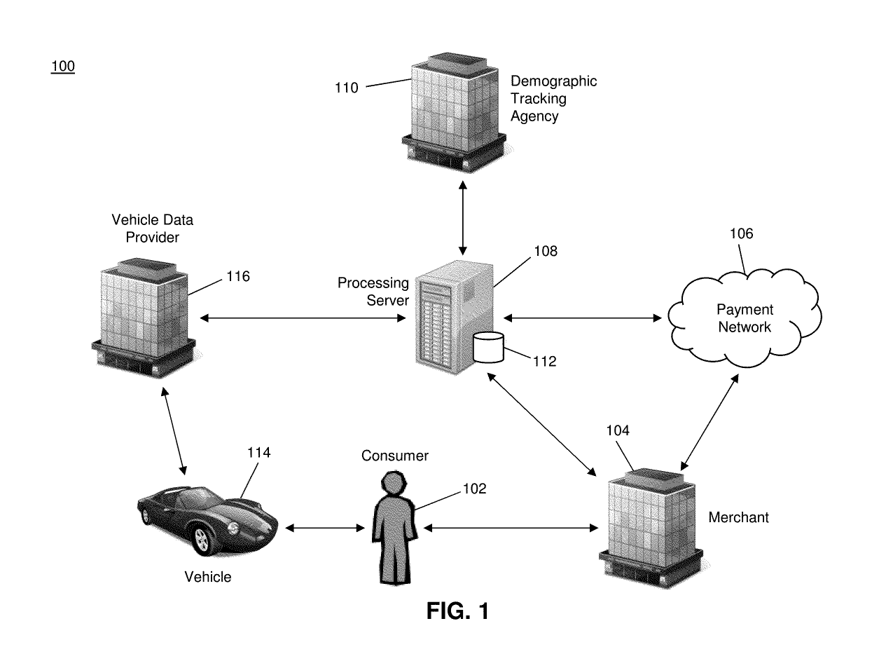

FIG. 1 illustrates a system 100 for linking consumer vehicle data to consumer transaction history.

A consumer 102 may engage in one or more payment transactions at a merchant 104. The payment transaction or transactions may be conducted in person (e.g., at a physical location of the merchant 104), or remotely, such as via the Internet, telephone, by mail, etc. The transaction may be processed via a payment network 106. The payment network 106 may transmit a copy of the authorization request or transaction data included therein to a processing server 108, discussed in more detail below. The processing server 108 may store the transaction data in a consumer profile of a consumer database 112, also discussed in more detail below, associated with the consumer 102. In an exemplary embodiment, the transaction data may only be stored in a consumer profile associated with the particular consumer 102 with the permission of the consumer 102.

The processing server 108 may receive demographic characteristics associated with the consumer 102 from a demographic tracking agency 110 or other third party. The demographic characteristics may include: age, gender, income, marital status, familial status, residential status, occupation, education, zip code, postal code, street address, county, city, state, country, etc. The processing server 108 may store the demographic characteristics in the consumer profile associated with the consumer 102. In an exemplary embodiment, the consumer profile associated with the consumer 102 may not include any personally identifiable information. In some instances, the consumer 102 may be grouped with a plurality of consumers having similar or the same demographic characteristics.

The consumer 102 may be associated with a vehicle 114. The vehicle 114 may be any type of vehicle suitable for performing the functions disclosed herein as will be apparent to persons having skill in the relevant art, such as a car, truck, van, motorcycle, bicycle, tractor, etc. The vehicle 114 may be associated with one or more pieces of vehicle data. The vehicle data may include identifying data associated with the vehicle 114, some of which may be unique, such as a vehicle identification number (VIN), license plate number, registration number, make, model, year, condition, etc. In some embodiments, the vehicle data may be identifiable upon observation of the vehicle 114 or encoded in a form that may be readily identifiable upon observation of the vehicle 114, such as a machine-readable code displayed on the vehicle 114 or a transmission emitted by a transmitter mounted on or within the vehicle 114.

The system 100 may include a vehicle data provider 116. The vehicle data provider 116 may be configured to store the vehicle data associated with the vehicle 114. The vehicle data provider 116 may be any entity, system, device, etc. suitable for performing the functions as disclosed herein, such as a department of motor vehicles, department of transportation, the processing server 108, etc. In some instances, the vehicle 114 itself may operate as the vehicle data provider 116.

The vehicle data provider 116 may be configured to furnish the stored vehicle data to the processing server 108, which may then store the data in corresponding consumer profiles in the consumer database 112. In some embodiments, the vehicle data provider 116 may provide vehicle data to the processing server 108 associated with demographic characteristics corresponding to the consumer 102 associated with the respective vehicle data. In such an embodiment, the processing server 108 may match the vehicle data to one or more consumer profiles based on the demographic characteristics and the consumer characteristics of the one or more consumer profiles. In other embodiments, the processing server 108 may transmit demographic characteristics for one or more consumer profiles to the vehicle data provider 116. The vehicle data provider 116 may then identify vehicle data corresponding to the consumer characteristics, and distribute the identified vehicle data to the processing server 108.

The processing server 108 may then store the vehicle data in the corresponding one or more consumer profiles. Methods for identifying correspondence between demographic characteristics and consumer characteristics are discussed in more detail below. Additional methods for obtaining the vehicle data for one or more consumers without personally identifying a consumer will be apparent to persons having skill in the relevant art. Additional methods and systems for associating consumers based on consumer characteristics and the grouping of consumers for privacy of the consumers can be found in U.S. patent application Ser. No. 13/437,987, entitled “Protecting Privacy in Audience Creation,” to Curtis Villars et al., filed Apr. 3, 2012, which is herein incorporated by reference in its entirety.

The processing server 108 may then have transaction history and vehicle data for a consumer 102 linked together in a consumer profile associated with the consumer 102. In an exemplary embodiment, the consumer profile may not include any personally identifiable information for the consumer 102, except with the express consent of the consumer 102. By linking transaction history with vehicle data, the processing server 108, or a third party, such as an advertiser, that may receive the data from the processing server 108, may be able to obtain significantly more data from a consumer's combined vehicle data and transaction history than utilizing either set of data alone.

### System for Processing Payment Transactions Based on Vehicle Data

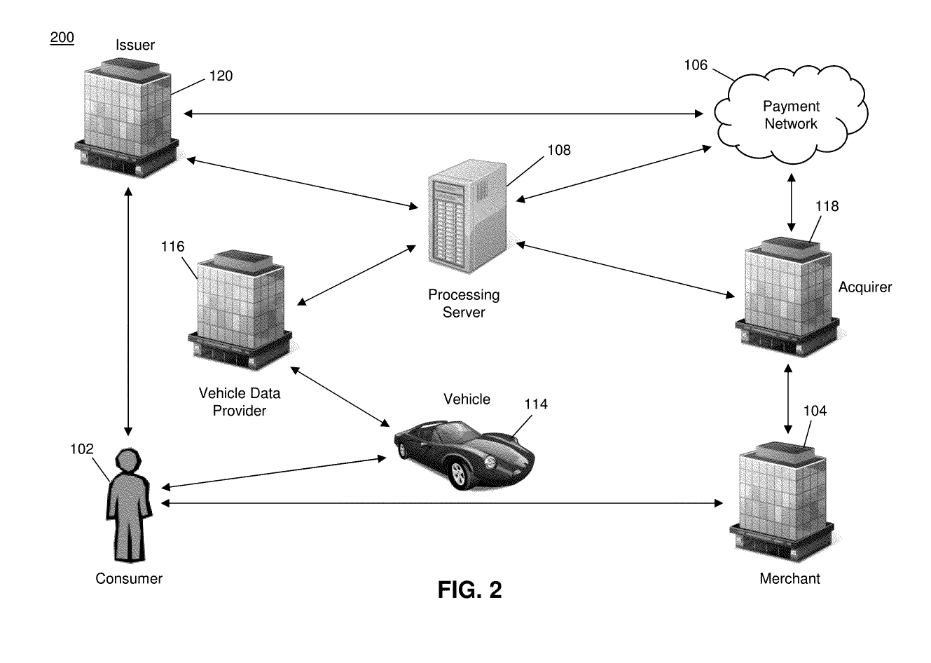

FIG. 2 illustrates a system 200 for the scoring and processing of a payment transaction based on vehicle data for a vehicle linked with a consumer involved in the payment transaction.

The consumer 102 may be associated with the vehicle 114. The consumer 102 may also have one or more payment accounts registered with an issuer 120, such as an issuing bank. The consumer 102 may initiate a payment transaction with the merchant 104 for the purchase of goods or services. As part of the conducting of the payment transaction, the consumer 102 may present payment information corresponding to a payment account (e.g., held with the issuer 120) for which the consumer 102 is authorized to use to pay the merchant 104.

The merchant 104 may forward transaction data for the payment transaction, including the payment information, to an acquirer 118. The acquirer 118 may generate an authorization request for the payment transaction and may submit the authorization request to the payment network 106 for processing. The payment network 106 may transmit a copy of the authorization request to the processing server 108 for the generation of a transaction score. In an alternative embodiment, the acquirer 118 may submit the authorization request directly to the processing server 108.

The processing server 108 may identify the consumer 102 based on the payment information and/or other data (e.g., a consumer identifier, such as an identification number associated with the consumer 102) included in the authorization request. In some instances, the processing server 108 may request consumer identification information from the issuer 120 based on the payment information included in the authorization request.

The processing server 108 may then request vehicle data from the vehicle data provider 116. The vehicle data provider 116 may identify a geographic location of the vehicle 114 associated with the consumer 102. Methods for identifying the geographic location of the vehicle 114 include using the global positioning system (e.g., via a transmitter included in the vehicle 114), vehicle recognition via traffic light or other cameras, vehicle identification via prepaid toll services, cellular triangulation, and other suitable systems as will be apparent to persons having skill in the relevant art. The vehicle data provider 116 may then transmit the vehicle data including the geographic location of the vehicle 114 associated with the consumer 102 to the processing server 108. In some embodiments, the vehicle data provider 116 may transmit the vehicle data to the processing server 108 without a request, such as at predetermined intervals or at predetermined periods of time.

The processing server 108 may then identify a transaction score for the payment transaction based on the vehicle data and the transaction data. The transaction score may be favorable if the vehicle 114 is identified as being located near the merchant 104 at the time of the payment transaction. The transaction score may be unfavorable if the vehicle 114 is identified as being at a location far from the merchant 104 at the time of the payment transaction, which may indicate that the consumer 102 is not present at the merchant 104, and that a fraudster may be attempting to use the payment account. In many instances, the transaction score may also be based on additional criteria and one or more fraud rules, such as traditional fraud rules and criteria as will be apparent to persons having skill in the relevant art.

The processing server 108 may then forward the identified transaction score (e.g., and the authorization request, if applicable) to the payment network 106. The payment network 106 may then process the payment transaction using methods and systems that will be apparent to persons having skill in the relevant art, with the identified transaction score being considered. In some embodiments, the processing server 108 may transmit the transaction score to the issuer 120 for use in approving or denying the payment transaction. In a further embodiment, the transaction score may be requested directly by the issuer 120 prior to the receipt of an authorization request by the issuer 120 from the payment network 106.

The identification of transaction scores by the processing server 108 based on vehicle location information may provide for increased fraud detection and prevention. Systems and methods that use mobile computing devices, traditional identification information, and other such information may be more easily compromised, as a nefarious party may be able to steal or otherwise compromise a consumer's mobile device or identification more easily than a consumer's vehicle. In many instances, a consumer 102 may not be near their vehicle 114 when payment information is stolen or compromised. In such an instance, when the perpetrator attempts to conduct a payment transaction using the stolen or compromised payment information, the lack of proximity of the vehicle 114 to the site of the transaction may result in denial of the transaction, which may prevent fraud from occurring on the payment account. As a result, the system 200 may provide for increased protection against fraud based on vehicle data.

### Processing Server

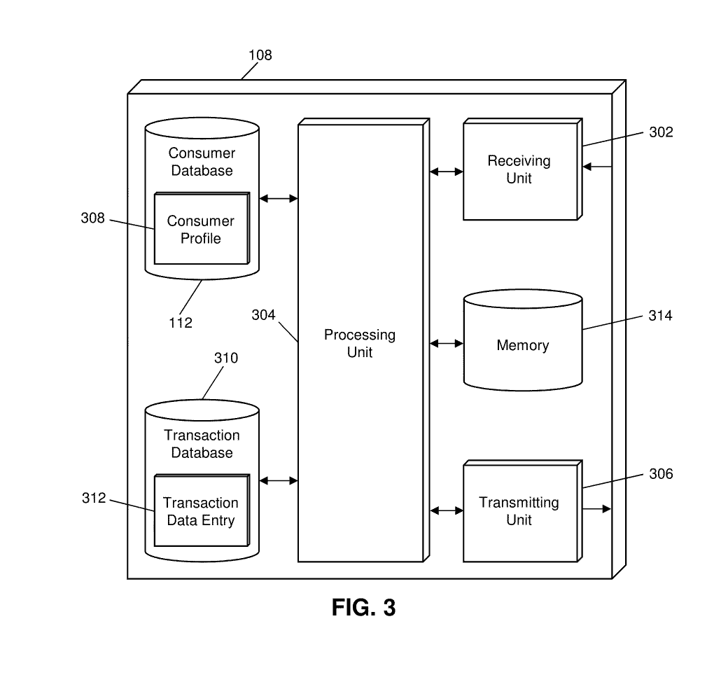

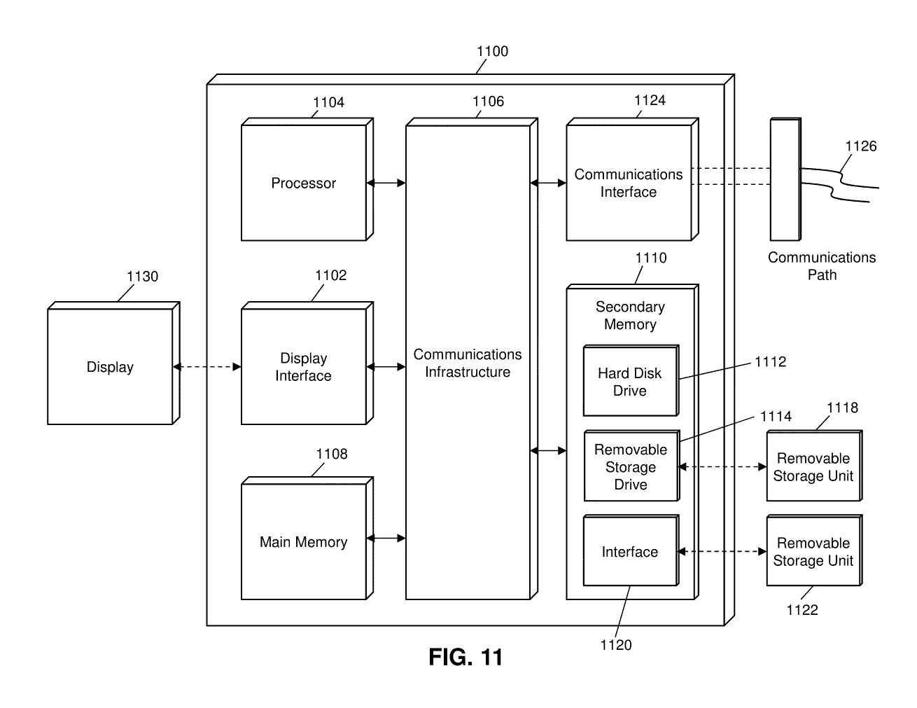

FIG. 3 illustrates an embodiment of the processing server 108 of the systems 100 and 200. It will be apparent to persons having skill in the relevant art that the embodiment of the processing server 108 illustrated in FIG. 3 is provided as illustration only and may not be exhaustive to all possible configurations of the processing server 108 suitable for performing the functions as discussed herein. For example, the computer system 1100 illustrated in FIG. 11 and discussed in more detail below may be a suitable configuration of the processing server 108.

The processing server 108 may include a receiving unit 302. The receiving unit 302 may be configured to receive data over one or more networks via one or more network protocols. The receiving unit 302 may be configured to receive transaction data, demographic characteristic data, and vehicle data. The receiving unit 302 may be further configured to receive authorization request data or transaction data from the merchant 104, payment network 106, or issuer 120, and vehicle notifications from the vehicle data provider 116 including a geographic location of the vehicle 114.

The processing server 108 may also include a processing unit 304. The processing unit 304 may be configured to store received transaction data in a transaction database 310 as one or more transaction data entries 312. Each transaction data entry 312 may include data related to a corresponding payment transaction, such as a consumer identifier, merchant identifier, transaction amount, transaction time and/or date, geographic location, merchant name, product data, coupon or offer data, a point-of-sale identifier, or other suitable information as will be apparent to persons having skill in the relevant art. In some embodiment, each transaction data entry may also include demographic characteristics for a consumer (e.g., consumer characteristics) involved in the corresponding payment transaction.

The processing unit 304 may also be configured to store a plurality of consumer profiles 308 in the consumer database 112. Each consumer profile 308 may include data related to a consumer (e.g., the consumer 102), including at least a plurality of consumer characteristics. In some embodiments, each consumer profile 308 may also include a plurality of transaction data entries 312. In an exemplary embodiment, each consumer profile 308 may not include personally identifiable information unless expressly consented to by the corresponding consumer 102. In some embodiments, each consumer profile 308 may be associated with a specific set of consumer characteristics and may accordingly be related to a generic consumer of those characteristics rather than an actual consumer 102.

The processing unit 304 may be configured to link consumer profiles 308 with transaction data entries 312 based on demographic characteristics. The processing unit 304 may also be configured to link consumer profiles 308 including transaction data entries 312 with vehicle data received by the receiving unit 302. The processing unit 304 may be configured to link the consumer profiles 308 with the vehicle data via demographic characteristics included in the consumer profiles 308 and in the received vehicle data. In some instances, the processing unit 304 may match vehicle data to transaction history based on a predefined number of demographic characteristics (e.g., at least the predefined number of characteristics must match). In other instances, transaction history and vehicle data may be matched via algorithms or other systems and methods that will be apparent to persons having skill in the relevant art. In some embodiments, the processing unit 304 may store the received vehicle data in the linked consumer profile 308.

The processing server 108 may also include a transmitting unit 306. The transmitting unit 306 may be configured to transmit data over one or more networks via one or more network protocols. The transmitting unit 306 may be configured to transmit requests for data, such as to the demographic tracking agency 110 and/or the vehicle data provider 116. The transmitting unit 306 may also be configured to transmit transaction history and/or vehicle data, or a consumer profile 308 including linked transaction history and vehicle data, in response to a request from a third party (e.g., an advertiser).

The processing unit 304 may be further configured to identify a transaction score for a payment transaction. The transaction score may be based on a vehicle geographic location included in vehicle data or a vehicle notification and transaction data received by the receiving unit 302. In some embodiments, the transaction score may be further based on one or more transaction scoring rules, which may be stored in a memory 314 of the processing server 108. The memory 314 may further include additional data for identifying a transaction score for a payment transaction as will be apparent to persons having skill in the relevant art. The transmitting unit 306 may be configured to transmit the identified transaction score to the payment network 106, issuer 120, or other suitable entity.

### Method for Linking Vehicle Data to Transaction History

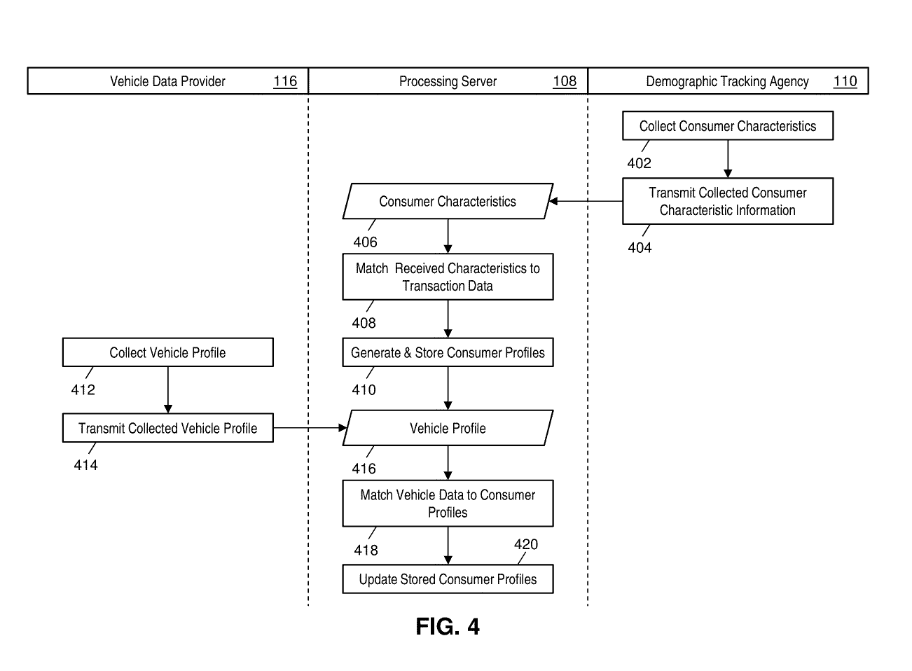

FIG. 4 illustrates a method for linking consumer vehicle data to transaction history.

In step 402, the demographic tracking agency 110 may collect demographic characteristics for one or more consumers. Methods and systems for collecting demographic characteristics will be apparent to persons having skill in the relevant art. The demographic tracking agency 110 may collect the information and may, in step 404, transmit the collected demographic characteristic information to the processing server 108.

In step 406, the processing server 108 may receive the demographic characteristic information. In step 408, the processing unit 304 of the processing server 108 may match the received demographic characteristic information to transaction data entries 312 included in the transaction database 310. In step 410, the processing unit 304 may generate consumer profiles 308 for matched transaction history and demographic characteristics (e.g., consumer characteristics) and store the consumer profiles 308 in the consumer database 112. In an exemplary embodiment, the processing unit 304 may bucket or otherwise modify the consumer characteristic information and/or transaction data to render the corresponding consumer profile 308 not personally identifiable. In some instances, the processing unit 304 may group transaction data entries 312 for multiple consumers sharing consumer characteristics into a single consumer profile 308.

In step 412, the vehicle data provider 116 may store vehicle profiles for one or more vehicles 114 associated with consumers 102, the vehicle profiles including vehicle data and a plurality of demographic characteristics that are associated with the respective consumers 102. In step 414, the vehicle data provider 116 may transmit the collected vehicle profile to the processing server 108. The processing server 108 may, in step 416, receive the vehicle profile from the vehicle data provider 116.

In step 418, the processing unit 304 of the processing server 108 may match the received vehicle data to the consumer profiles 208 based on matching of the demographic and consumer characteristics. In step 420, the processing unit 304 may update the consumer profiles 308 to include and/or be associated with the matched vehicle data.

### Method for Distributing a Consumer Profile

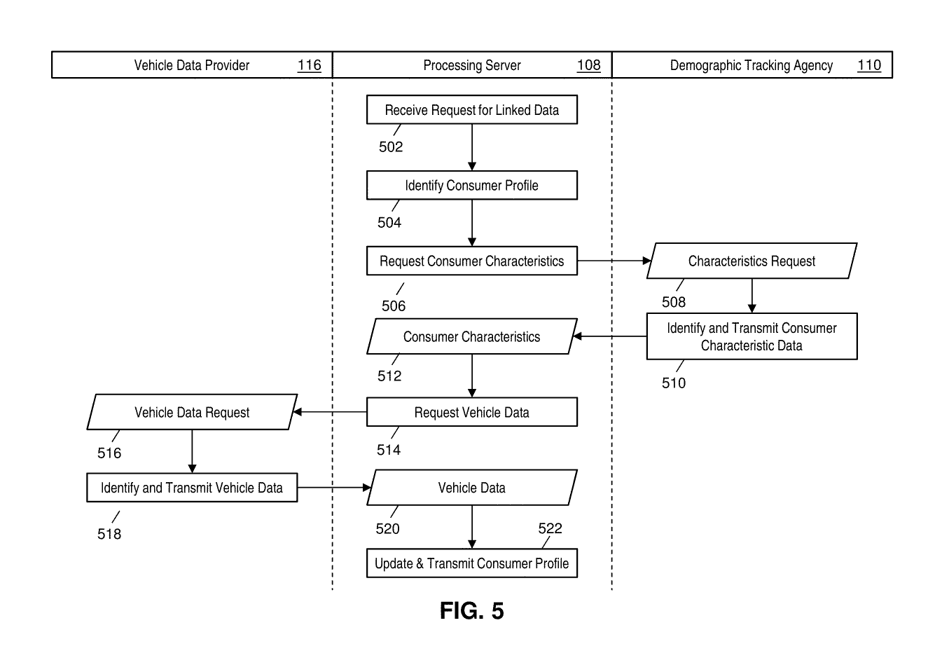

FIG. 5 illustrates a method for distributing a consumer profile including linked vehicle data and transaction history.

In step 502, the processing server 108 may receive (e.g., via the receiving unit 302) a request for linked consumer vehicle and transaction data. The request for linked data may include a consumer identifier or other identifying information, such as consumer characteristics. In step 504, the processing unit 304 of the processing server 108 may identify, in the consumer database 112, a consumer profile 308 based on the information included in the request.

In step 506, the processing server 108 may transmit (e.g., via the transmitting unit 306), a request for consumer characteristics for the consumer associated with the identified consumer profile 308 to the demographics tracking agency 110. In step 508, the demographic tracking agency 110 may receive the request, and, in step 510, may identify consumer characteristics associated with the consumer and transmit them back to the processing server 108. In step 512, the processing server 108 may receive the consumer characteristics associated with the consumer 102 related to the identified consumer profile 308.

In step 514, the processing server 108 may request vehicle data for a vehicle 114 associated with the consumer 102 from the vehicle data provider 116. The vehicle data request may include the previously received consumer characteristics. In step 516, the vehicle data provider 116 may receive the vehicle data request, and, in step 518, identify vehicle data associated with the consumer characteristics received in the vehicle data request. The vehicle data provider 116 may transmit the vehicle data to the processing server 108, which may receive the vehicle data in step 520.

In step 522, the processing server 108 may update the consumer profile 308 to include the received vehicle data, and may transmit the consumer profile 308 and/or the included transaction history and vehicle data as a response to the initially received request. In an exemplary embodiment, the consumer profile 308 may not include any personally identifiable information for the related consumer 102. In other embodiments, the processing server 108 may remove and/or render personally unidentifiable any personally identifiable information included in the consumer profile 308.

### Linking Vehicle Data to Transaction History

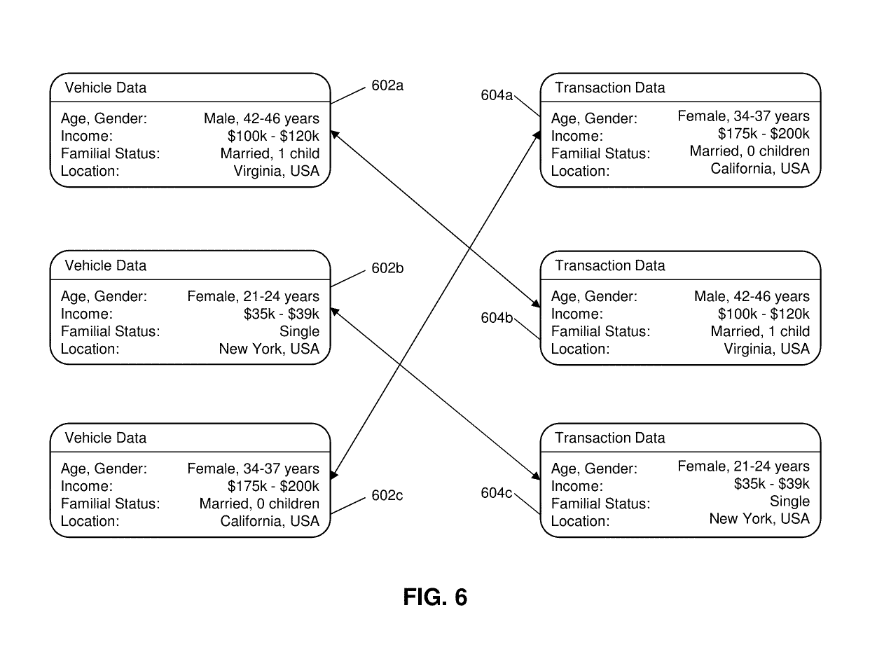

FIG. 6 illustrates the linking of consumer vehicle data 602 to transaction history 604 using demographic characteristics.

Each set of vehicle data 602, illustrated in FIG. 6 as vehicle data 602a, 602b, and 602c, may correspond to a consumer 102 and include a plurality of demographic characteristics. For example, vehicle data 602a corresponds to a consumer 102 that is a male, of an age between 42 and 46 years old, has an income between $100,000 and $120,000, is married, has one child, and lives in Virginia. In some embodiments, the vehicle data 602a may correspond to a plurality of consumers each having the same demographic characteristics data.

Each set of transaction data 604, illustrated in FIG. 6 as transaction data 604a, 604b, and 604c, may correspond to a consumer 102 or a plurality of consumers 102, and include a plurality of consumer characteristics associated with the corresponding consumer or consumers 102. For example, transaction data 604a may correspond to a consumer 102 that is a female, of an age between 34 and 37 years old, has an income between $175,000 and $200,000, is married, has no children, and lives in California.

The processing unit 304 of the processing server 108 may identify the demographic characteristics for each of the vehicle data 602 and transaction data 604 and match the two sets of data based on common demographic and consumer characteristics. For example, in the example illustrated in FIG. 6, the processing unit 304 may match vehicle data 602a with transaction data 604b, vehicle data 602b with transaction data 604c, and vehicle data 602c with transaction data 604a. The processing unit 304 may then store the linked data in one or more consumer profiles 308 including the corresponding consumer characteristics.

In some embodiments, the demographic characteristics for the vehicle data 602 may not directly correspond to the consumer characteristics for the transaction data 604. In such an instance, the processing unit 304 may be configured to link the data based on a predefined number of matching characteristics. For example, if the transaction data 604b was associated with a consumer 102 having two children (instead of one child as illustrated in FIG. 6), while the vehicle data 602a is associated with a consumer 102 having only one child, the processing unit 304 may still link the two sets of data because the sets have at least five matching demographic characteristics including age, gender, income, marital status, and geographic location.

### Transaction Score Generation Based on Vehicle Data

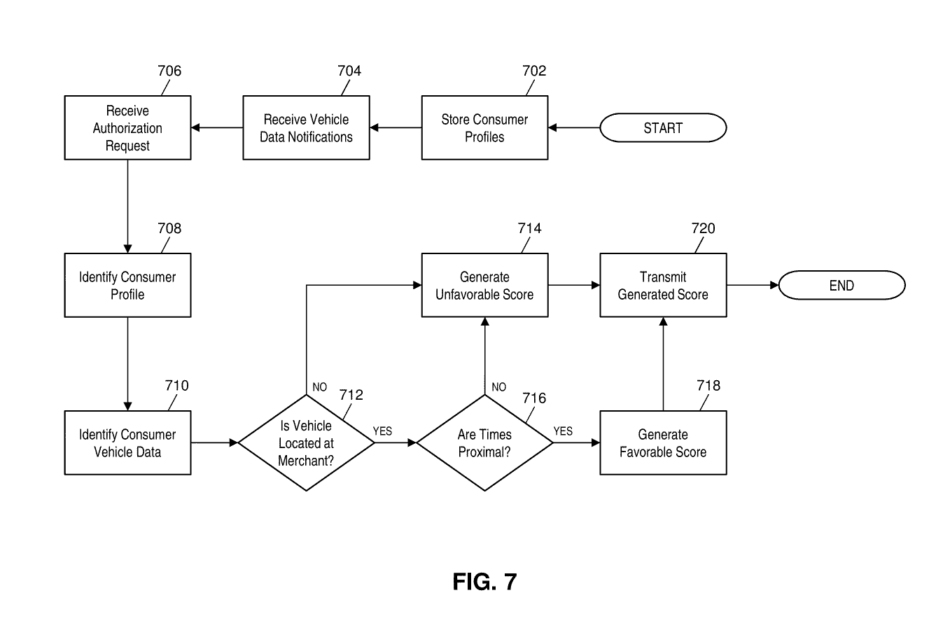

FIG. 7 illustrates a process for the generation of a transaction score for a payment transaction based on transaction data and vehicle data of a vehicle 114 associated with a consumer 102 involved in the payment transaction.

In step 702, the processing server 108 may store a plurality of consumer profiles 308 in the consumer database 112. Each consumer profile 308 may include at least a consumer identifier associated with a related consumer 102 and vehicle data associated with a vehicle 114 associated with the related consumer 102. The consumer identifier may be any unique value suitable for identification of the consumer profile 308 and/or the related consumer 102, such as an identification number or a payment account number.

In step 704, the receiving unit 302 of the processing server 108 may receive a vehicle data notification (e.g., from the vehicle data provider 116). The vehicle data notification may include at least vehicle data associated with a specific vehicle 114, a geographic location where the specific vehicle 114 was identified, and a vehicle date and/or time at which the specific vehicle 114 was identified as being at the geographic location. The geographic location may be represented in latitude and longitude, as a street address, as a zip or postal code, or in any other suitable representation as will be apparent to persons having skill in the relevant art.

In step 706, the receiving unit 302 may receive an authorization request, such as from the payment network 106. The authorization request may include at least transaction data (e.g., a transaction amount, point of sale identifier, offer data, product data, etc.), a merchant identifier associated with a merchant 104 involved in the payment transaction, a specific consumer identifier associated with a specific consumer 102 involved in the payment transaction, and a transaction date and/or time.

In step 708, the processing unit 304 of the processing server 108 may identify a specific consumer profile 308 stored in the consumer database 112 where the included consumer identifier corresponds to the specific consumer identifier included in the authorization request. In step 710, the processing unit 304 may identify vehicle information corresponding to the vehicle 114 associated with the specific consumer 102, based on the vehicle data included in the specific consumer profile 308, including any received vehicle notifications.

In step 712, the processing unit 304 may determine if the vehicle 114 is located at the merchant 104 based on the geographic location of the vehicle 114 as indicated in the vehicle notification. The geographic location of the merchant 104 may be determined based on the merchant identifier included in the authorization request (e.g., using a look-up table or other suitable method) and/or the authorization request, which may include a data field including a geographic location where the authorization request originated from (e.g., the merchant 104). If the vehicle 114 is not located at (e.g., or near) the merchant 104, then, in step 714, the processing unit 304 may generate an unfavorable transaction score.

If the vehicle 114 is located at or near the merchant 104, then, in step 716, the processing unit 304 may further determine if the vehicle date and/or time at which the vehicle 114 is located at the geographic location is proximal to the transaction date and/or time of the payment transaction indicated in the authorization request. If the times are not proximal (e.g., the vehicle 114 was located at or near the merchant 104, but not at a time near the time the transaction occurred), then the processing unit 304 may generate an unfavorable transaction score. If the times are proximal, which may indicate that the consumer's vehicle 114 was at the merchant 104 when the transaction occurred, then, in step 718, the processing unit 304 may generate a favorable transaction score.

In step 720, the transmitting unit 306 of the processing server 108 may transmit the generated transaction score to the payment network 106 or other suitable entity for processing of the payment transaction.

### Exemplary Method for Linking Vehicle Data to Transaction History

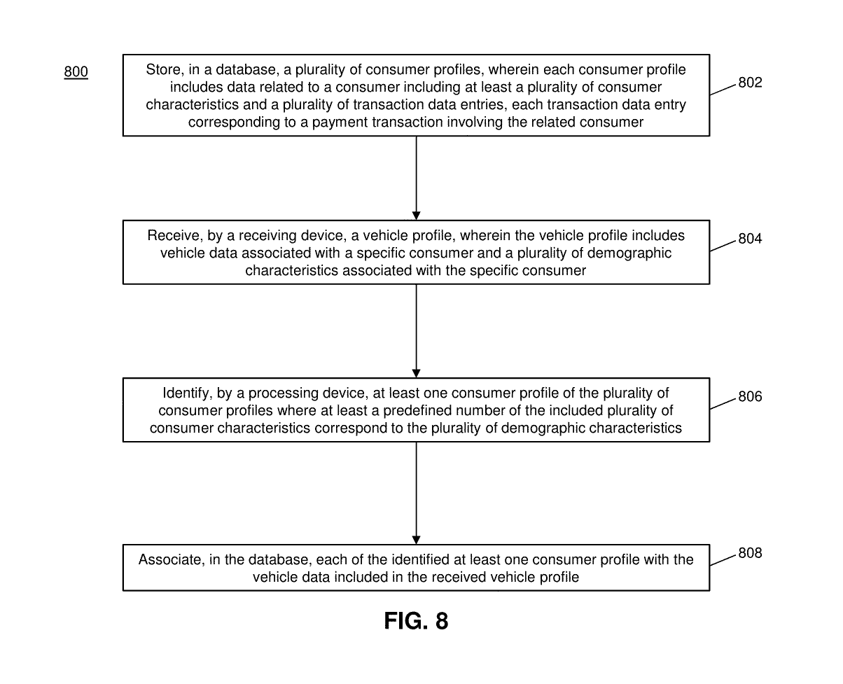

FIG. 8 illustrates a method 800 for linking consumer vehicle data to transaction history using demographic characteristics.

In step 802, a plurality of consumer profiles (e.g., the consumer profiles 308) may be stored in a database (e.g., the consumer database 112), wherein each consumer profile 308 includes data related to a consumer (e.g., the consumer 102) including at least a plurality of consumer characteristics and a plurality of transaction data entries (e.g., transaction data entries 312), each transaction data entry 312 corresponding to a payment transaction involving the related consumer 102. In some embodiments, the plurality of consumer characteristics may not be personally identifiable.

In one embodiment, the plurality of consumer characteristics may include at least one of: age, gender, income, marital status, familial status, residential status, occupation, education, zip code, postal code, street address, county, city, state, and country. In some embodiments, each transaction data entry 312 may include at least transaction data, a consumer identifier associated with the related consumer 102, and a merchant identifier associated with a merchant (e.g., the merchant 104) involved in the corresponding payment transaction. In a further embodiment, the transaction data may include at least one of: a transaction amount, product data, transaction time and/or date, geographic location, coupon data, and point-of-sale identifier.

In step 804, a vehicle profile may be received, by a receiving device (e.g., the receiving unit 302), wherein the vehicle profile includes vehicle data associated with a specific consumer 102 and a plurality of demographic characteristics associated with the specific consumer. In one embodiment, the vehicle data may include at least one of: license plate number, registration number, vehicle identification number, make, model, year, and condition. In some embodiments, the plurality of demographic characteristics may not be personally identifiable.

In step 806, at least one consumer profile 308 of the plurality of consumer profiles may be identified, by a processing device (e.g., the processing unit 304), where at least a predefined number of the included plurality of consumer characteristics correspond to the plurality of demographic characteristics. In step 808, each of the identified at least one consumer profiles 308 may be associated, in the database 112, with the vehicle data included in the received vehicle profile.

### Exemplary Method for Distributing a Linked Consumer Profile

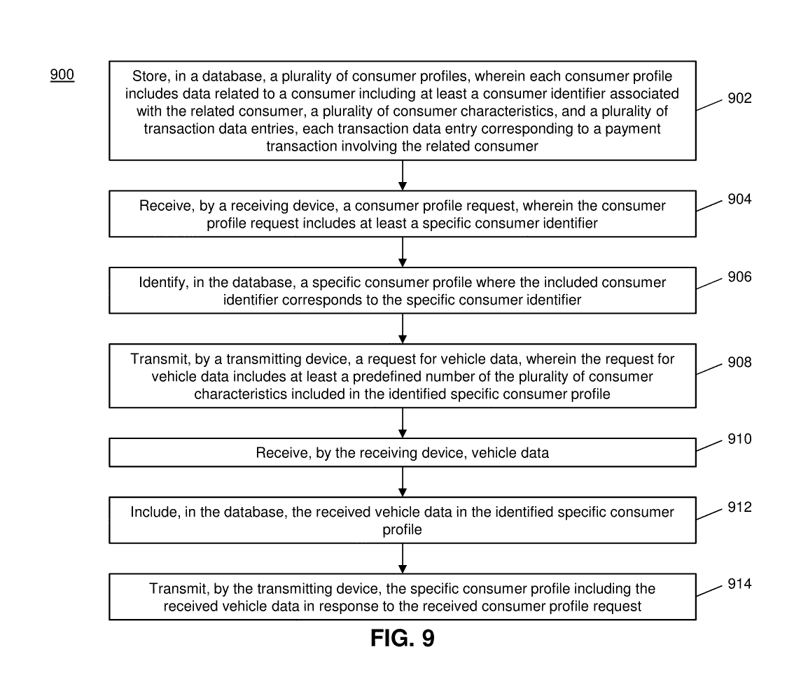

FIG. 9 illustrates a method 900 for distributing a consumer profile including vehicle data and transaction history linked based on demographic characteristics.

In step 902, a plurality of consumer profiles (e.g., the consumer profiles 308) may be stored, in a database (e.g., the consumer database 112), wherein each consumer profile 308 includes data related to a consumer (e.g., the consumer 102), including at least a consumer identifier associated with the related consumer 102, a plurality of consumer characteristics, and a plurality of transaction data entries (e.g., transaction data entries 312), each transaction data entry 312 corresponding to a payment transaction involving the related consumer 102. In some embodiments, the plurality of demographic characteristics may not be personally identifiable.

In one embodiment, the plurality of consumer demographic characteristics may include at least one of: age, gender, income, marital status, familial status, residential status, occupation, education, zip code, postal code, street address, county, city, state, and country. In some embodiments, each transaction data entry 312 may include at least transaction data, a consumer identifier associated with the related consumer 102, and a merchant identifier associated with a merchant (e.g., the merchant 104) involved in the corresponding payment transaction. In a further embodiment, the transaction data may include at least one of: a transaction amount, product data, transaction time and/or date, geographic location, coupon data, and point-of-sale identifier.

In step 904, a consumer profile request may be received, by a receiving device (e.g., the receiving unit 302), wherein the consumer profile request includes at least a specific consumer identifier. In step 906, a specific consumer profile 308 may be identified, in the database 112, where the included consumer identifier corresponds to the specific consumer identifier. In step 908, a request for vehicle data may be transmitted, by a transmitting device (e.g., the transmitting unit 306), wherein the request for vehicle data includes at least the plurality of consumer characteristics included in the identified specific consumer profile 308.

In step 910, the receiving device 302 may receive vehicle data. In one embodiment, the request for vehicle data may further include a predefined number, the received vehicle data may be associated with demographic characteristics, and a number of the plurality of consumer characteristics included in the specific consumer profile 908 that correspond to the plurality of demographic characteristics is at least the predefined number. In a further embodiment, the plurality of demographic characteristics may not be personally identifiable. In some embodiments, the vehicle data may include at least one of: license plate number, registration number, vehicle identification number, make, model, year, and condition.

In step 912, the received vehicle data may be included, in the database 112, in the identified specific consumer profile 308. In step 914, the specific consumer profile 308 including the received vehicle data may be transmitted, by the transmitting device 306, in response to the received consumer profile request.

### Exemplary Method for Processing a Payment Transaction

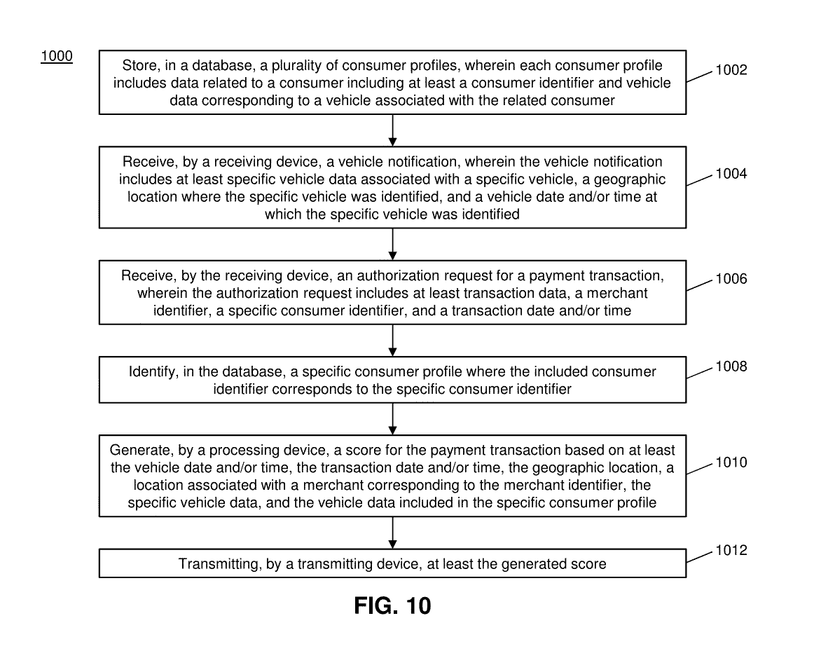

FIG. 10 illustrates a method 1000 for processing a payment transaction using a transaction score generated based on linked vehicle data.

In step 1002, a plurality of consumer profiles (e.g., consumer profiles 308) may be stored, in a database (e.g., the consumer database 112), wherein each consumer profile 308 includes data related to a consumer (e.g., the consumer 102) including at least a consumer identifier and vehicle data corresponding to a vehicle (e.g., the vehicle 114) associated with the related consumer 102. In some embodiments, the vehicle data may include at least one of: license plate number, registration number, vehicle identification number, make, model, year, and condition.

In step 1004, a vehicle notification may be received, by a receiving device (e.g., the receiving unit 302), wherein the vehicle notification includes at least specific vehicle data associated with a specific vehicle 114, a geographic location where the specific vehicle 114 was identified, and a vehicle date and/or time at which the specific vehicle 114 was identified. In step 1006, an authorization request for a payment transaction may be received, by the receiving device 302, wherein the authorization request includes transaction data, a merchant identifier, a specific consumer identifier, and a transaction date and/or time.

In step 1008, a specific consumer profile 308 may be identified, in the database 112, where the included consumer identifier corresponds to the specific consumer identifier. In step 1010, a score for the payment transaction may be generated, by a processing device (e.g., the processing unit 304), based on at least the vehicle date and/or time, the transaction date and/or time, the geographic location, a location associated with a merchant (e.g., the merchant 104) corresponding to the merchant identifier, the specific vehicle data, and the vehicle data included in the specific consumer profile 308.

In step 1012, a transmitting device (e.g., the transmitting unit 306), may transmit at least the generated score. In one embodiment, the method 1000 may further include updating, by the processing device 304, the authorization request to include the generated score, wherein transmitting the generated score may include transmitting the updated authorization request included in the generated score.

### Computer System Architecture

FIG. 11 illustrates a computer system 1100 in which embodiments of the present disclosure, or portions thereof, may be implemented as computer-readable code. For example, the processing server 108 of FIGS. 1 and 2 may be implemented in the computer system 1100 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4, 5, and 7-10.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 1118, a removable storage unit 1122, and a hard disk installed in hard disk drive 1112.

Various embodiments of the present disclosure are described in terms of this example computer system 1100. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1104 may be a special purpose or a general purpose processor device. The processor device 1104 may be connected to a communications infrastructure 1106, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 1100 may also include a main memory 1108 (e.g., random access memory, read-only memory, etc.), and may also include a secondary memory 1110. The secondary memory 1110 may include the hard disk drive 1112 and a removable storage drive 1114, such as a floppy disk drive, a magnetic tape drive, an optical disk drive, a flash memory, etc.

The removable storage drive 1114 may read from and/or write to the removable storage unit 1118 in a well-known manner. The removable storage unit 1118 may include a removable storage media that may be read by and written to by the removable storage drive 1114. For example, if the removable storage drive 1114 is a floppy disk drive or universal serial bus port, the removable storage unit 1118 may be a floppy disk or portable flash drive, respectively. In one embodiment, the removable storage unit 1118 may be non-transitory computer readable recording media.

In some embodiments, the secondary memory 1110 may include alternative means for allowing computer programs or other instructions to be loaded into the computer system 1100, for example, the removable storage unit 1122 and an interface 1120. Examples of such means may include a program cartridge and cartridge interface (e.g., as found in video game systems), a removable memory chip (e.g., EEPROM, PROM, etc.) and associated socket, and other removable storage units 1122 and interfaces 1120 as will be apparent to persons having skill in the relevant art.

Data stored in the computer system 1100 (e.g., in the main memory 1108 and/or the secondary memory 1110) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 1100 may also include a communications interface 1124. The communications interface 1124 may be configured to allow software and data to be transferred between the computer system 1100 and external devices. Exemplary communications interfaces 1124 may include a modem, a network interface (e.g., an Ethernet card), a communications port, a PCMCIA slot and card, etc. Software and data transferred via the communications interface 1124 may be in the form of signals, which may be electronic, electromagnetic, optical, or other signals as will be apparent to persons having skill in the relevant art. The signals may travel via a communications path 1126, which may be configured to carry the signals and may be implemented using wire, cable, fiber optics, a phone line, a cellular phone link, a radio frequency link, etc.

The computer system 1100 may further include a display interface 1102. The display interface 1102 may be configured to allow data to be transferred between the computer system 1100 and external display 1130. Exemplary display interfaces 1102 may include high-definition multimedia interface (HDMI), digital visual interface (DVI), video graphics array (VGA), etc. The display 1130 may be any suitable type of display for displaying data transmitted via the display interface 1102 of the computer system 1100, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 1108 and secondary memory 1110, which may be memory semiconductors (e.g., DRAMs, etc.). These computer program products may be means for providing software to the computer system 1100. Computer programs (e.g., computer control logic) may be stored in the main memory 1108 and/or the secondary memory 1110. Computer programs may also be received via the communications interface 1124. Such computer programs, when executed, may enable computer system 1100 to implement the present methods as discussed herein. In particular, the computer programs, when executed, may enable processor device 1104 to implement the methods illustrated by FIGS. 4, 5, and 7-10, as discussed herein. Accordingly, such computer programs may represent controllers of the computer system 1100. Where the present disclosure is implemented using software, the software may be stored in a computer program product and loaded into the computer system 1100 using the removable storage drive 1114, interface 1120, and hard disk drive 1112, or communications interface 1124.

Techniques consistent with the present disclosure provide, among other features, systems and methods for linking vehicle data to transaction history, distributing linked consumer profiles, and processing payment transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for linking vehicle data to transaction history, comprising:
storing, in a database, a plurality of consumer profiles, wherein each consumer profile includes data related to a consumer including at least a plurality of consumer characteristics and a plurality of transaction data entries, each transaction data entry corresponding to a payment transaction involving the related consumer;
receiving, by a receiving device, a vehicle profile, wherein the vehicle profile includes vehicle data associated with a specific consumer and a plurality of demographic characteristics associated with the specific consumer;
identifying, by a processing device, at least one consumer profile of the plurality of consumer profiles where at least a predefined number of the included plurality of consumer characteristics correspond to the plurality of demographic characteristics; and
associating, in the database, each of the identified at least one consumer profile with the vehicle data included in the received vehicle profile.

2. The method of claim 1, wherein the plurality of consumer characteristics includes at least one of: age, gender, income, marital status, familial status, residential status, occupation, education, zip code, postal code, street address, county, city, state, and country.

3. The method of claim 1, wherein each transaction data entry includes at least transaction data, a consumer identifier associated with the related consumer, and a merchant identifier associated with a merchant involved in the corresponding payment transaction.

4. The method of claim 3, wherein the transaction data includes at least one of: a transaction amount, product data, transaction time and/or date, geographic location, coupon data, and point-of-sale identifier.

5. The method of claim 1, wherein the plurality of consumer characteristics are not personally identifiable.

6. The method of claim 1, wherein the vehicle data includes at least one of: license plate number, registration number, vehicle identification number, make, model, year, and condition.

7. The method of claim 1, wherein the plurality of demographic characteristics are not personally identifiable.

8. A method for distributing a linked consumer profile, comprising:
storing, in a database, a plurality of consumer profiles, wherein each consumer profile includes data related to a consumer including at least a consumer identifier associated with the related consumer, a plurality of consumer characteristics, and a plurality of transaction data entries, each transaction data entry corresponding to a payment transaction involving the related consumer;
receiving, by a receiving device, a consumer profile request, wherein the consumer profile request includes at least a specific consumer identifier;
identifying, in the database, a specific consumer profile where the included consumer identifier corresponds to the specific consumer identifier;
transmitting, by a transmitting device, a request for vehicle data, wherein the request for vehicle data includes at least a predefined number of the plurality of consumer characteristics included in the identified specific consumer profile;
receiving, by the receiving device, vehicle data;
including, in the database, the received vehicle data in the identified specific consumer profile; and
transmitting, by the transmitting device, the specific consumer profile including the received vehicle data in response to the received consumer profile request.

9. The method of claim 8, wherein the vehicle data is associated with a plurality of demographic characteristics, and at least the predefined number of the plurality of consumer characteristics included in the specific consumer profile correspond to the plurality of demographic characteristics.

10. The method of claim 8, wherein the plurality of consumer characteristics includes at least one of: age, gender, income, marital status, familial status, residential status, occupation, education, zip code, postal code, street address, county, city, state, and country.

11. The method of claim 8, wherein each transaction data entry includes at least transaction data, a consumer identifier associated with the related consumer, and a merchant identifier associated with a merchant involved in the corresponding payment transaction.

12. The method of claim 11, wherein the transaction data includes at least one of: a transaction amount, product data, transaction time and/or date, geographic location, coupon data, and point-of-sale identifier.

13. The method of claim 8, wherein the plurality of consumer characteristics are not personally identifiable.

14. The method of claim 8, wherein the vehicle data includes at least one of: license plate number, registration number, vehicle identification number, make, model, year, and condition.

15. The method of claim 8, wherein the plurality of demographic characteristics are not personally identifiable.

16. A method for processing a payment transaction, comprising:
storing, in a database, a plurality of consumer profiles, wherein each consumer profile includes data related to a consumer including at least a consumer identifier and vehicle data corresponding to a vehicle associated with the related consumer;
receiving, by a receiving device, a vehicle notification, wherein the vehicle notification includes at least specific vehicle data associated with a specific vehicle, a geographic location where the specific vehicle was identified, and a vehicle date and/or time at which the specific vehicle was identified;
receiving, by the receiving device, an authorization request for a payment transaction, wherein the authorization request includes at least transaction data, a merchant identifier, a specific consumer identifier, and a transaction date and/or time;
identifying, in the database, a specific consumer profile where the included consumer identifier corresponds to the specific consumer identifier;
generating, by a processing device, a score for the payment transaction based on at least the vehicle date and/or time, the transaction date and/or time, the geographic location, a location associated with a merchant corresponding to the merchant identifier, the specific vehicle data, and the vehicle data included in the specific consumer profile; and
transmitting, by a transmitting device, at least the generated score.

17. The method of claim 16, wherein the vehicle data includes at least one of: license plate number, registration number, vehicle identification number, make, model, year, and condition.

18. The method of claim 16, further comprising:
updating, by the processing device, the authorization request to include the generated score, wherein
transmitting at least the generated score includes transmitting the updated authorization request including the generated score.

19. A system for linking vehicle data to transaction history, comprising:
a database configured to store a plurality of consumer profiles, wherein each consumer profile includes data related to a consumer including at least a plurality of consumer characteristics and a plurality of transaction data entries, each transaction data entry corresponding to a payment transaction involving the related consumer;
a receiving device configured to receive a vehicle profile, wherein the vehicle profile includes vehicle data associated with a specific consumer and a plurality of demographic characteristics associated with the specific consumer; and
a processing device configured to
identify at least one consumer profile of the plurality of consumer profiles where at least a predefined number of the included plurality of consumer characteristics correspond to the plurality of demographic characteristics, and
associate, in the database, each of the identified at least one consumer profile with the vehicle data included in the received vehicle profile.

20. The system of claim 19, wherein the plurality of consumer characteristics includes at least one of: age, gender, income, marital status, familial status, residential status, occupation, education, zip code, postal code, street address, county, city, state, and country.

21. The system of claim 19, wherein each transaction data entry includes at least transaction data, a consumer identifier associated with the related consumer, and a merchant identifier associated with a merchant involved in the corresponding payment transaction.

22. The system of claim 21, wherein the transaction data includes at least one of: a transaction amount, product data, transaction time and/or date, geographic location, coupon data, and point-of-sale identifier.

23. The system of claim 19, wherein the plurality of consumer characteristics are not personally identifiable.

24. The system of claim 19, wherein the vehicle data includes at least one of: license plate number, registration number, vehicle identification number, make, model, year, and condition.

25. The system of claim 19, wherein the plurality of demographic characteristics are not personally identifiable.

26. A system for distributing a linked consumer profile, comprising:
a database configured to store a plurality of consumer profiles, wherein each consumer profile includes data related to a consumer including at least a consumer identifier associated with the related consumer, a plurality of consumer characteristics, and a plurality of transaction data entries, each transaction data entry corresponding to a payment transaction involving the related consumer;
a receiving device configured to receive a consumer profile request, wherein the consumer profile request includes at least a specific consumer identifier;
a processing device configured to identify, in the database, a specific consumer profile where the included consumer identifier corresponds to the specific consumer identifier; and
a transmitting device configured to transmit a request for vehicle data, wherein the request for vehicle data includes at least a predefined the plurality of consumer characteristics included in the identified specific consumer profile, wherein
the receiving device is further configured to receive vehicle data,
the processing device is further configured to include, in the database, the received vehicle data in the identified specific consumer profile, and
the transmitting device is further configured to transmit the specific consumer profile including the received vehicle data in response to the received consumer profile request.

27. The system of claim 26, wherein the vehicle data is associated with a plurality of demographic characteristics, and at least the predefined number of the plurality of consumer characteristics included in the specific consumer profile correspond to the plurality of demographic characteristics.

28. The system of claim 26, wherein the plurality of consumer characteristics includes at least one of: age, gender, income, marital status, familial status, residential status, occupation, education, zip code, postal code, street address, county, city, state, and country.

29. The system of claim 26, wherein each transaction data entry includes at least transaction data, a consumer identifier associated with the related consumer, and a merchant identifier associated with a merchant involved in the corresponding payment transaction.

30. The system of claim 29, wherein the transaction data includes at least one of: a transaction amount, product data, transaction time and/or date, geographic location, coupon data, and point-of-sale identifier.

31. The system of claim 26, wherein the plurality of consumer characteristics are not personally identifiable.

32. The system of claim 26, wherein the vehicle data includes at least one of: license plate number, registration number, vehicle identification number, make, model, year, and condition.

33. A system for processing a payment transaction, comprising:
a database configured to store a plurality of consumer profiles, wherein each consumer profile includes data related to a consumer including at least a consumer identifier and vehicle data corresponding to a vehicle associated with the related consumer;
a receiving device configured to
receive a vehicle notification, wherein the vehicle notification includes at least specific vehicle data associated with a specific vehicle, a geographic location where the specific vehicle was identified, and a vehicle date and/or time at which the specific vehicle was identified, and
receive an authorization request for a payment transaction, wherein the authorization request includes at least transaction data, a merchant identifier, a specific consumer identifier, and a transaction date and/or time;
a processing device configured to
identify, in the database, a specific consumer profile where the included consumer identifier corresponds to the specific consumer identifier, and
generate a score for the payment transaction based on at least the vehicle date and/or time, the transaction date and/or time, the geographic location, a location associated with a merchant corresponding to the merchant identifier, the specific vehicle data, and the vehicle data included in the specific consumer profile; and
a transmitting device configured to transmit at least the generated score.

34. The system of claim 31, wherein the vehicle data includes at least one of: license plate number, registration number, vehicle identification number, make, model, year, and condition.

35. The system of claim 31, wherein
the processing device is further configured to update the authorization request to include the generated score, and
transmitting at least the generated score includes transmitting the updated authorization request including the generated score.
